(19) United States
(12) Patent Application Publication
(10) Pub. No.: US 2007/0198190 A1
(43) Pub. Date: Aug. 23, 2007

(54) Motor vehicle

(75) Inventors: Wolf-Dietrich Bauer, Leinfelden-Echterdingen (DE); Peter Ebel, Braunsbach (DE); Albert Kirchmann, Ostfildern (DE); Christian Mayer, Reutlingen (DE); Andreas Schwarzhaupt, Landau (DE); Gernot Spiegelberg, Heimsheim (DE); Wolfgang Stahl, Oberboihingen (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimierChrysler AG, Stuttgart (DE)

(21) Appl. No.: 10/569,375

(22) PCT Filed: Aug. 19, 2004
(86) PCT No.: PCT/EP04/09294

§ 371 Date: Oct. 4, 2006

(30) Foreign Application Priority Data
Aug. 26, 2003 (DE) 10339075.8

(51) Int. Cl. G08G 1/16; B60K 28/00; B60T 7/16

(52) U.S. Cl. 701/301; 180/271; 180/169

(57) ABSTRACT

A utility vehicle has an electronically controlled drive train which has at least one drive unit, one steering system and one braking system. In addition, the motor vehicle has a maneuvering assistance system with a display device, an input device and a control system. The display device displays an actual orientation and an actual position of the vehicle as well as the relatively close surroundings of the vehicle on a monitor. The input device inputs a desired orientation and a desired position for the vehicle. The control system processes a maneuvering algorithm and at the same time actuates the drive train to transfer the vehicle from its actual orientation and actual position into its desired orientation and desired position taking into account the vehicle surroundings.

### BACKGROUND AND SUMMARY OF THE INVENTION

The present invention relates to a motor vehicle, and in particular to a utility vehicle.

The motor vehicle shown, for example, in DE 100 32 179 A1 has an electronically controlled drive train which comprises at least one steering system, one braking system and one drive unit of the vehicle. Manually operated activation elements such as, for example, an accelerator pedal, a brake pedal and a steering handle or a joystick or drive stick which comprises the functions of the brake pedal, accelerator pedal and/or steering wheel, are provided for activating the drive train. When they are activated, the activation elements generate control commands which are executed by actuators of the respective components of the drive train. The commands are transferred electronically in the form of electrical signals. There is basically no need for mechanical or hydraulic positive coupling between the activation elements and the associated components of the drive train, the coupling being, for example, a steering column, a brake hydraulic system or a Bowden cable for the accelerator pedal. Such an electronically controlled drive train is thus a drive-by-wire system or generally an X-by-wire system.

When motor vehicles are maneuvered, in particular when they travel in reverse, a person to give instructions is useful especially in the case of trucks in order to reduce the risk of collision and risk of an accident. This is all the more so the case for vehicle combinations composed of a tractive unit and trailer or semitrailer which exhibit particularly complex kinematics when traveling in reverse. Since the person to give instructions is comparatively expensive for commercial vehicles, there is desire to simplify the maneuvering operation to such an extent that it is possible to do without a costly person to give instructions.

WO 03045726 A discloses a utility vehicle having a maneuvering assistance system. In one development, an emergency braking system is also disclosed and is intended to reduce the risk of a collision when maneuvering. Electronic actuation of the steering, of the brakes and of the drive is described for the purpose of operating these automatic driver assistance systems.

EP 1 332 948 A1 describes an embodiment of an automatic parking system for a motor vehicle. That system parks a vehicle automatically into a parking space after an input means has been activated. Further driver assistance systems are disclosed in DE 38 44 340 A and in DE 101 13 323 A.

The present invention is concerned with solving the above problem by providing an improved vehicle in which in particular maneuvering is simplified.

This problem has been solved according to the invention by means of the subject matter of the independent claim. Advantageous embodiments are the subject matter of the dependent claims.

The present invention is based on the general concept of equipping the motor vehicle with a maneuvering assistance system in which the actual situation of the vehicle with respect to the surroundings of the vehicle is displayed on a monitor, in which a requested desired situation for the vehicle can be predefined and in which a suitable maneuvering algorithm is used to actuate the drive train in such a way that the vehicle is transferred automatically from its actual situation into the requested desired situation while taking into account the surroundings of the vehicle.

For example, a passenger car which is configured according to the present invention can be parked automatically in a parking space to the side. Likewise, a vehicle combination according to the present invention can be actuated in such a way that its trailer is automatically moved in reverse to a (narrow) loading ramp. The display device proposed according to the present invention for displaying the actual situation of the vehicle and the current surroundings of the vehicle simplifies the inputting of the desired situation.

Furthermore, the monitor permits the satisfactory functioning of the maneuvering assistance system to be checked visually. The automatic maneuvering of the vehicle by way of a maneuvering algorithm makes it in particular possible to avoid hazardous situations which may arise due to the vehicle dynamics (rolling, tilting) or from the vehicle kinematics (jack-knifing of the vehicle combination). The operation of the vehicle is thus made safer.

A determining device which is fixed to the vehicle and has the purpose of acquiring the data for the actual position, the actual orientation and the surroundings of the vehicle can expediently be provided. With respect to the displaying of the actual situation of the vehicle and the current surroundings of the vehicle on the monitor, the vehicle according to the invention is autonomous in this embodiment, that is to say independent of external devices. The usability of the maneuvering assistance system is thus increased.

In addition or alternatively, a determining device which is remote from the vehicle can also be provided. The, said determining device can be connected to a data transmitter and thus permit data to be transmitted to a data receiver which is fixed to the vehicle and is connected to the maneuvering assistance system. For example, a dispatching center can be equipped with such a determining device which is remote from the vehicle, thus permitting greater precision to be obtained for the actual values of the position and orientation of the vehicle and for the surroundings of the vehicle, that is to say in particular the position of obstacles. For example, the positions of loading stations within the dispatching center are known and invariable so that the associated position data can be acquired comparatively precisely. Furthermore, a determining device which is remote from the vehicle can simplify the coordination of the maneuvering operation of a plurality of motor vehicles.

In one development, the input device communicates with the display device so that the display device additionally displays on the monitor the desired situation of the vehicle which has been input with the input device. The driver of the vehicle can thus particularly easily check whether the requested desired situation matches the surroundings of the vehicle which have been acquired. In one particularly convenient development, the desired situation can be input using an input element while the desired situation is simultaneously displayed on the monitor. The input element is configured, for example, such that a cursor can thus be adjusted on the monitor. As a result, the requested desired situation can be predefined particularly easily using the monitor. This thus results in particularly easy handling for the maneuvering assistance system.

The vehicle can also be equipped with an emergency braking system which communicates with a distance sensor system which is fixed to the vehicle and is configured to automatically brake the vehicle if the emergency braking system detects a risk of a collision between the vehicle and an obstacle. In one particularly expedient development of the present invention, the maneuvering assistance system can be coupled to such an emergency braking system so that the vehicle is automatically braked if a risk of a collision arises for the vehicle when the maneuvering algorithm is being processed. For example, the conditions of the surroundings of the vehicle may change during maneuvering, and this can be taken into account in this embodiment in order to avoid a collision. This development thus increases the safety of the vehicle.

### BRIEF DESCRIPTION OF THE DRAWINGS

Other objects, advantages and novel features of the present invention will become apparent from the following detailed description of the invention when considered in conjunction with the accompanying drawings.

FIG. 1 is a schematic side view of a vehicle according to the present invention,

FIG. 2 is a schematic circuit-diagram of a maneuvering assistance system according to the present invention,

FIG. 3 is a schematic diagram of a remote control device according to the present invention,

FIG. 4 is a schematic view of a vehicle according to the present invention,

FIG. 5 is a schematic view of a monitor display of the maneuvering assistance system according to the present invention, and

FIG. 6 is a view similar to FIG. 5 but of another embodiment.

### DETAILED DESCRIPTION OF THE PREFERRED EMBODIMENTS

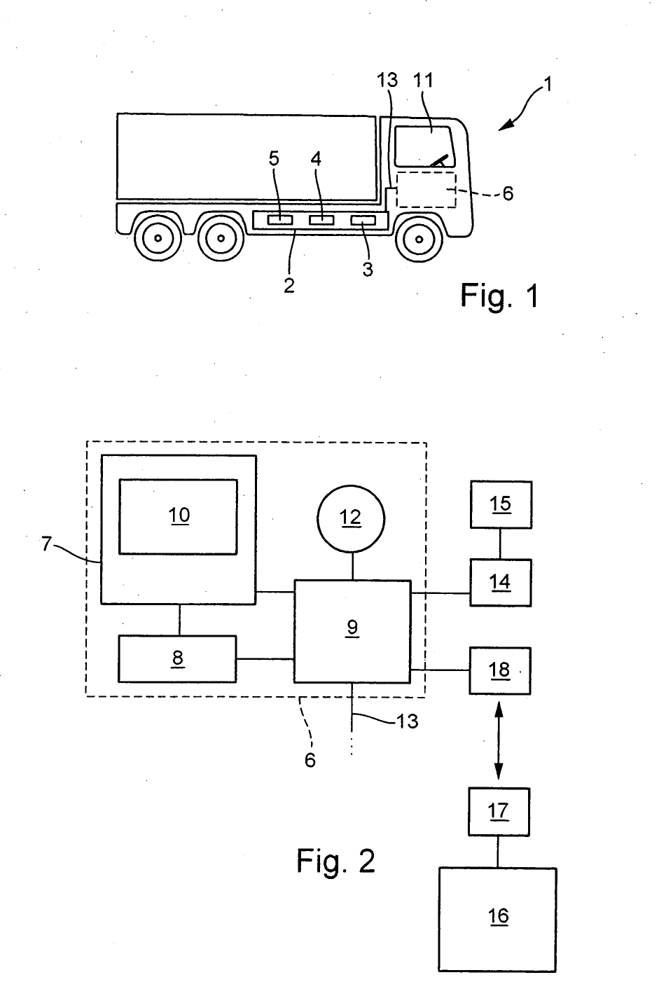

According to FIG. 1, a motor vehicle 1 according to the present invention is equipped with a drive train 2 which is of electronically controlled. The drive train 2 comprises at least one drive unit 3, a steering system 4 and a braking system 5. Furthermore, the drive train 2 may additionally have an electronically shifted transmission and a ride level control device. The drive train 2 can be operated or actuated by customary or conventional desired value signal transmitters (not illustrated here). For example, these desired value signal transmitters are an accelerator pedal, a steering wheel, a brake pedal and a gear shift lever. The driver of the vehicle can input his request into the vehicle 1 by the desired value signal transmitters. The desired value signal transmitters convert the driver's request into corresponding desired signals which are expediently fed to the drive train 2 in the form of a movement vector. The drive train 2 or its components (drive unit 3, steering system 4 and braking system 5) can then process the control signals in order thus to fulfill the driver's request.

As shown in FIG. 1, the motor vehicle 1 may be a truck. However, the motor vehicle 1 may also be formed by a vehicle combination composed of a tractive unit and trailer or semitrailer. The vehicle 1 can also be any other utility vehicle or even a passenger car.

The motor vehicle according to the present invention is also equipped with a maneuvering assistance system 6 which is represented in FIG. 1 by a box which is shown with a dash line. Referring to FIG. 2, the maneuvering assistance system 6 comprises at least one display device 7, an input device 8 and a control system 9. The display device 7 operates with a monitor 10 which is expediently arranged in a driver's cab 11 (such as shown in FIG. 1) of the vehicle 1 so that the driver of the vehicle can see it.

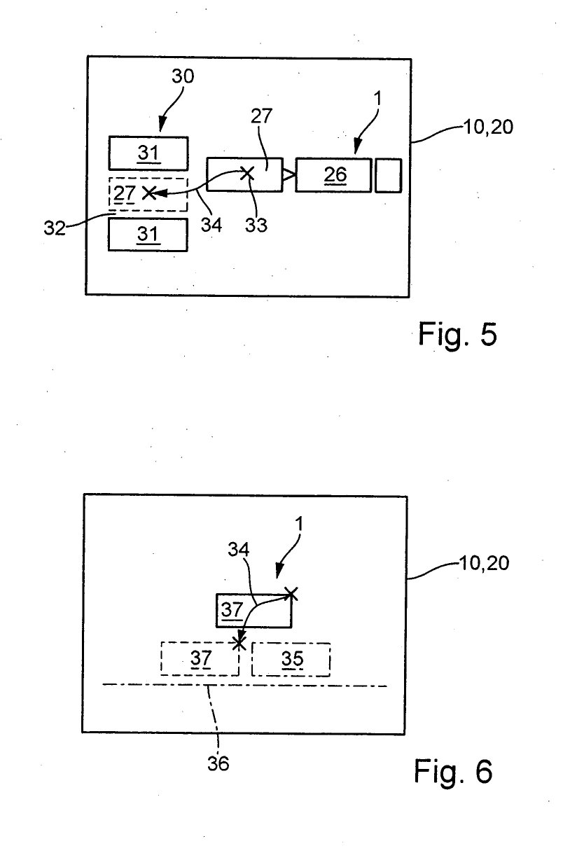

The display device 7 is constructed so that it can display or represent an actual orientation and an actual position of the vehicle 1 as well as the relatively close surroundings of the vehicle 1 on the monitor 10. Examples of such displays are explained in more detail below with reference to FIGS. 5 and 6.

In the present context, the term “vehicle position” describes the geographic position of the vehicle 1, while the term “vehicle orientation” describes the orientation of a longitudinal axis of the vehicle 1 in a reference coordinate system which can be defined, for example, by the points of the compass. The relatively close surroundings of the vehicle comprise at least partially an area which surrounds the vehicle 1 at a distance, and the surroundings thus include obstacles in the vicinity of the vehicle, for example other vehicles, crash barriers, posts, lighting pylons, curbstones, house walls, walls and the like.

The input device 8 is configured so that it can be used to input a desired orientation and a desired position for the vehicle 1 into the maneuvering assistance system 6.

The control system 9 has access to a maneuvering algorithm 12 and is connected to the drive train 2 via a line 13. The control system 9 is configured in such a way that it can process the maneuvering algorithm 12. When the maneuvering algorithm 12 is processed, the control system 9 actuates the drive train 2 so that it transfers the vehicle 1 from the actual orientation and the actual position into the desired orientation and desired position, and this transfer is carried out while taking into account the surroundings of the vehicle. That is a collision between the vehicle 1 and an obstacle is automatically avoided, and the obstacles are driven around.

The maneuvering assistance system 6 also comprises a determining device 14 which is fixed to the vehicle and which can be used to acquire the data for the actual position, the actual orientation and the surroundings of the vehicle. For this purpose, the determining device 14 communicates with the display device 7, here by way of the control system 9. The determining device 14 interacts with a distance sensor system 15 which is fixed to the vehicle and which is either mounted on the vehicle 1 specifically for the maneuvering assistance system 6 or is already present on the vehicle 1 and is used within the scope of other systems for acquiring distances between the vehicle 1 and obstacles (for examples a distance maintaining system).

In addition or alternatively, the maneuvering assistance system 6 can have a determining device 16 which is remote from the vehicle and which also serves to acquire the data for the actual position, the actual orientation and the surroundings of the vehicle. The determining device 16 which is remote from the vehicle is connected to a first data transmission device 17 which comprises in particular a data transmitter. The maneuvering assistance system 6 is then equipped with a second data transmission device 18 which is fixed to the vehicle and which comprises, in particular, a data receiver. The second data transmission device communicates with the display device 7, here again via the control system 9.

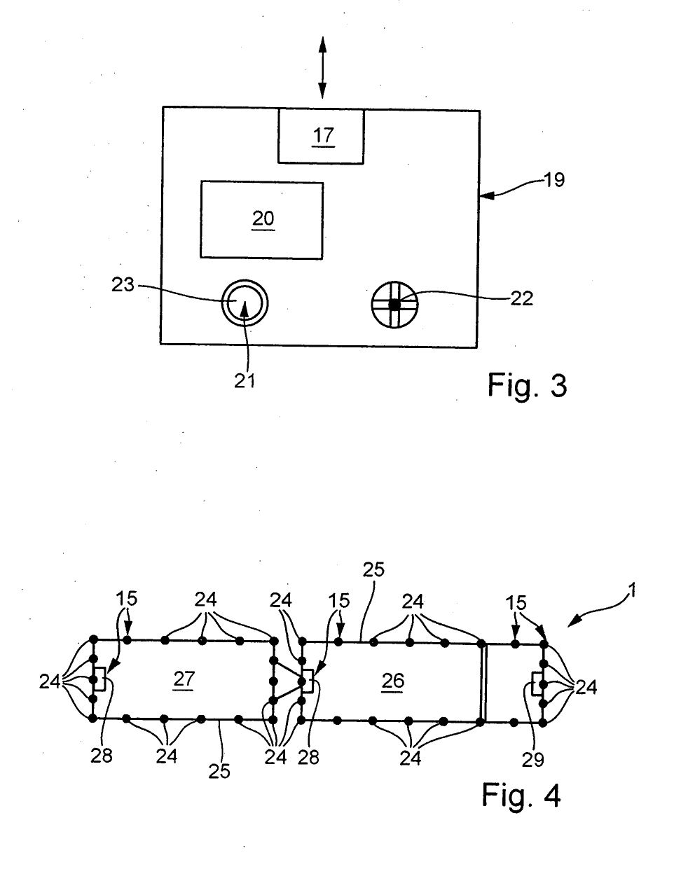

As seen in FIG. 3, the maneuvering assistance system according to the invention can also be equipped with a remote control device 19 which is likewise equipped with a first data transmission device 17 which has both a data transmitter and a data receiver. So that the components of the maneuvering assistance system 6 which are fixed to the vehicle can communicate with the remote control device 19, the maneuvering assistance system 6 is also equipped in this embodiment with a second transmission device 18 which is fixed to the vehicle and which also has a data transmitter and a data receiver. The remote control device 19 is also equipped with an additional monitor 20 and with an additional input device 21. The remote control device 19 can optionally also have at least one activation element 22 to generate control signals for activating the drive train 2, which signals pass to the drive train 2 via the data transmission devices 17, 18. In this way, the vehicle 1 can be activated remotely using the remote control device 19. The activation element 22 is, for example, a drive stick with which the most important components of the drive train 2, specifically the drive unit 3, steering system 4 and braking system 5, can be activated. The data transmission devices 17, 18 expediently communicate in a wirefree fashion.

The additional input device 21 is equipped here with an input element 23 which can be used to input the desired orientation and the desired position of the vehicle 1 into the system manually. This input element 23 is, for example, a trackball or the like. The additional input device 21 can also have at least one further input element. It is clear that the input device 8 which is fixed to the vehicle has corresponding input elements, but these need not be illustrated here.

According to one advantageous development, the input device, that is to say the input device 8 which is fixed to the vehicle and/or the additional input device 21 which is remote from the vehicle, communicates with the display device 7. The display device 7 is then expediently configured so that it additionally displays on the respective monitor 10 or 20 the desired orientation and desired position of the vehicle 1 which have been input using the respective input device 8, 21. As a result, the user can see directly the result of his input and check, and possibly correct it. The maneuvering assistance system 6 is thus made considerably easier to handle.

As shown in FIG. 4, the distance sensor system 15 which is fixed to the vehicle can have, for example, a plurality of distance sensors 24 which are arranged running completely around and along an external contour 25 of the vehicle 1. That is the distance sensors 24 are located both on the front of the vehicle and on the rear of the vehicle as well as on the two sides of the vehicle. In the embodiment shown here, the vehicle 1 is a vehicle combination which is composed of a tractive unit 26 and a trailer 27. The distance sensors 24 are arranged running around and along the external contours 25 of the two components of the vehicle combination 26, 27. The surroundings of the vehicle 1 can be scanned along the entire external contour 25 of the vehicle using these distance sensors 24. The distance sensors 24 may, for example, be embodied as ultrasonic sensors.

Additionally or alternatively, the distance sensor system 15 can have a camera 28 on the rear of the vehicle 1. Since the present illustration is concerned with a vehicle combination 26, 27, such a camera 28 is mounted both on the rear of the trailer 27 and on the rear of the tractive unit 26. The surroundings to the rear of the vehicle 1 can be photographed using such a camera 28.

Additionally or alternatively, the distance sensor system 15 can have a radar device 29 which is arranged on the front of the vehicle 1 and which can be used to scan the surroundings in front of the vehicle 1 for obstacles. The aforesaid components of the distance sensor system 15 are in each case components which may be already present within the scope of other vehicle systems on the vehicle 1. As already explained, the maneuvering assistance system 6 according to the present invention then expediently has recourse to the elements of the distance sensor system 15 which are present in any case on the vehicle 1. The expenditure on implementing the maneuvering assistance system 6 according to the invention is thus comparatively low.

Further components of a distance sensor system 15 which is fixed to the vehicle may be, for example, a laser scanner, a satellite navigation device such as, for example, a GPS, and a compass which can be read out.

The method of functioning of the maneuvering assistance system 6 according to the invention is explained in more detail below with reference to FIGS. 5 and 6.

In the example shown in FIG. 5, the vehicle 1 is also a vehicle combination 26, 27. The vehicle 1 is represented on the monitor 10 or 20 with its current orientation and position. Furthermore, the surroundings 30, which comprise here for example two other trailers 31 between which there is a gap 32, are displayed on the monitor 10, 20. The trailer 27 of the vehicle 1 is to be reversed into this gap 32. For this purpose, the driver of the vehicle activates the respective input element, for example the trackball 23. The input element 23 is coupled, for example, to a cursor 33 which is represented on the monitor 10, 20. By appropriately activating the input element 23, the driver of the vehicle can then position the cursor 23 on the trailer 27 and displace and/or rotate a copy of the trailer contour 27′ on the monitor 10, 20 as desired by way of an appropriate input command, for example by depressing the trackball 23. The copy of the trailer contour 27′ is represented in FIG. 5 by a dashed line and it is moved, by way of example, into the gap 32 between the trailers 31 in the surroundings 30 in accordance with an arrow 34 using the input element 23. This requested position and requested orientation for the trailer 27 can be input as a desired orientation and desired position into the maneuvering assistance system 6 by a corresponding input command.

Then, the actual maneuvering process during which the control system 9 processes the maneuvering algorithm 12 is started, in particular manually. At the same time, the control system 9 actuates the drive train 2 so that the trailer 27 is automatically transferred from its actual orientation and actual position into the requested desired orientation and desired position.

As already mentioned above, the actual orientation and actual position and the surroundings 30 of the vehicle can also be acquired using an external determining device 16 and displayed on the monitor 10, 20. For example, a dispatching center may be equipped with a comparatively precisely operating position and orientation detecting device for the vehicles 1 located at it, and the device 16 can be used to determine relatively precisely the current actual values for the orientation and position of the vehicles 1 located at the dispatching center. Furthermore, fixed conditioning factors in the surroundings such as, for example, loading ramps, buildings and other obstacles are known to such a system and are also measured relatively precisely. As a result, in particular the surroundings of the vehicle 1 in a comparatively large area can be displayed completely on the monitor 10, 20. The data for the actual orientation, actual position and surroundings can be transferred to the maneuvering assistance system 6 by the data transmission devices 17, 18.

The vehicle 1 can also be equipped with an emergency braking system of known type (not illustrated). Such an emergency braking system communicates with the distance sensor system 15 which is fixed to the vehicle and causes the vehicle 1 to be braked automatically and in good time if the emergency braking system detects a risk of a collision between the vehicle 1 and an obstacle in the surroundings of the vehicle 1.

The maneuvering assistance system 6 according to the invention can then expediently be coupled to such an emergency braking system, specifically so that the emergency braking system is automatically activated while the maneuvering assistance system 6 is operating. This ensures the vehicle 1 can be braked automatically in good time even if a risk of collision arises while the control system 9 is processing the maneuvering algorithm. For example, a risk of collision may arise if a mobile obstacle is located in or moves into the path of the vehicle 1 which is acquired by means of the maneuvering algorithm.

According to FIG. 6, the vehicle 1 may also be a passenger car 37. The distance sensor system 15 which is fixed to the vehicle has, for example, a comparatively small range in this embodiment so that only a comparatively small area of the surroundings of the vehicle can be displayed on the monitor 10, 20. In the example, the passenger car 37 is located laterally next to a parked vehicle 35, whose external contour the distance sensor system 15 detects and displays on the screen 10, 20 only the part shown by an unbroken line. The rest of the vehicle contour which is shown by a dot-dashed line, and a curbstone 36 which is also represented by a dot-dashed line, are not detected by the distance sensor system 15 and accordingly cannot be displayed on the monitor 10, 20. Nevertheless, the driver of the vehicle can use the input element to displace a copy of the external contour 37′ of the passenger car 37 on the monitor again in accordance with the arrow 34 in order thus to input the requested desired position and desired orientation for the vehicle 1 or 37 into the system. After the maneuvering operation starts, the control system 9 can again process the maneuvering algorithm 15 which then automatically parks the vehicle 1 or the passenger car 37 to the rear of and laterally behind the parked vehicle 35.

1-7. (canceled)

8. A motor vehicle comprising an electronically controlled drive train with at least one drive unit, a steering system and a braking system, a maneuvering assistance system having a display device, an input device configured to input a desired orientation and a desired position for the vehicle and a control system configured to process a maneuvering algorithm and actuate the drive train to transfer the vehicle from an actual orientation and actual position into a desired orientation and desired position taking into account vehicle surroundings, wherein
an emergency braking system operatively communicates with a distance sensor system operatively associated with the vehicle and arranged to automatically brake the vehicle if a risk of a collision between the vehicle and an obstacle is detected, the maneuvering assistance system being operatively coupled to the emergency braking system to effect automatic braking of the vehicle if a risk of a collision arises when the maneuvering algorithm is being processed, the input device being arranged to communicate with the display device, which additionally displays on a monitor the desired orientation and desired position of the vehicle which have been input with the input device and is configured to display relatively close surroundings of the vehicle on the monitor, a copy of a vehicle contour/trailer contour on the monitor is at least one of selecting displaceable and rotatable on the monitor, and a requested position for the vehicle is able to be input as a desired position into the maneuvering assistance system with an appropriate input command.

9. The motor vehicle as claimed in claim 8, wherein a determining device is operatively associated with the vehicle and communicates with a distance sensor system, the vehicle or optionally includes a distance sensor system.

10. The motor vehicle as claimed in claim 8, wherein a determining device remote from the vehicle is configured to acquire data for the actual position, the actual orientation and the surroundings of the vehicle and is operatively connected to a data transmitter, and a data receiver is operatively associated with the vehicle and is connected to the maneuvering assistance system.

11. The motor vehicle as claimed in claim 10, wherein a determining device is operatively associated with the vehicle and communicates with a distance sensor system, the vehicle or optionally includes a distance sensor system.

12. The motor vehicle as claimed in claim 8, wherein a remote control device having an additional monitor and an additional input device is operatively associated with data transmission devices via which the remote control device communicates at least with the control system.

13. The motor vehicle as claimed in claim 8, wherein a remote control device has at least one activation element for manually activating the drive train.

14. The motor vehicle as claimed in claim 13, wherein a determining device is operatively associated with the vehicle and communicates with a distance sensor system, the vehicle or optionally includes a distance sensor system.

15. The motor vehicle device as claimed in claim 14, wherein a determining device remote from the vehicle is configured to acquire data for the actual position, the actual orientation and the surroundings of the vehicle and is operatively connected to a data transmitter, and a data receiver is operatively associated with the vehicle and is connected to the maneuvering assistance system.

16. The motor vehicle as claimed in claim 8, wherein the input device has at least one input element for manually inputting the desired orientation and desired position.

17. The motor vehicle as claimed in claim 16, wherein a remote control device has at least one activation element for manually activating the drive train.

18. The motor vehicle as claimed in claim 17, wherein a determining device is operatively associated with the vehicle and communicates with a distance sensor system, the vehicle or optionally includes a distance sensor system.

19. The motor vehicle as claimed in claim 8, wherein a distance sensor system is operatively associated with the vehicle and has at least one of a plurality of distance sensors arranged around and along an external contour of the vehicle, at least one camera operatively arranged at a rear of the vehicle, a laser scanner, a radar device, a satellite navigation device, GPS, and a readable compass.

20. The motor vehicle as claimed in claim 8, wherein the motor vehicle is a utility vehicle.

21. The motor vehicle as claimed in claim 19, wherein the satellite navigation device is a GPS device.
